(19) United States
(12) Patent Application Publication
(10) Pub. No.: US 2004/0139121 A1
(43) Pub. Date: Jul. 15, 2004

(54) Data embedding method and system

(76) Inventors: Nithin Nagaraj, Bangalore (IN); Rakesh Mullick, Bangalore (IN)

Correspondence Address: Patrick S. Yoder, Fletcher, Yoder & Van Someren, P.O. Box 692289, Houston, TX, 77269-2289, US

(21) Appl. No.: 10/339,974

(22) Filed: Jan. 10, 2003

(51) Int. Cl. G06F 12/00

(52) U.S. Cl. 707/200

(57) ABSTRACT

A method for embedding a data set in a host data is provided. The method comprises, identifying available portions in the host data that are not required for lossless decoding of the host data and embedding the data set in the available portions of the host data. The resulting combined data is stored in a memory device.

### BACKGROUND OF THE INVENTION

The invention relates generally to data embedding techniques and more specifically to a system and method for embedding data.

In various applications, it is often required to embed a data set in a host data and the resulting combined data is often transmitted to different clients. The clients, upon receiving the combined data, may recover the host data and the data set by using a parser.

The problem with the above approach is that a client not having a parser will not be able to recover the host data in a lossless manner. In other words, the embedded data set is a distorted representation of the original data set. In various applications, especially in the field of medical sciences, such distortions are undesirable.

It would therefore be desirable to embed a data set in a host image such that a client may be able to recover the resulting combined data in a lossless fashion without the use of a parser.

### BRIEF DESCRIPTION OF THE INVENTION

Briefly, in accordance with one embodiment of the present technique, a method for embedding a data set in host data is provided. The method comprises, identifying available portions in the host data that are not required for lossless decoding of the host data and embedding the data set in the available portions of the host data. The resulting combined data is stored in a memory device.

In another embodiment, a method for embedding a data in a discrete pixel image is provided. The method comprises identifying available portions in the discrete pixel image that are not required for lossless reconstruction of the image and embedding the data in the available portions of the discrete pixel image. The resulting combined image is stored in a memory device.

An alternate embodiment provides a system for embedding a data set in host data. The system comprises means for identifying available portions in the host data that are not required for lossless decoding of the host data, means for embedding the data set in the available portions of the host data and means for storing the resulting combined data in a memory device.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic representation of a general-purpose computer system;

FIG. 2 is a schematic representation of an exemplary imaging system;

FIG. 3 is a flow chart illustrating the method by which a data set is embedded in a host data;

FIG. 4 is a representation of an example image;

FIG. 5 is a bar chart indicating different values of each pixel of the image; and

FIG. 6 is a bar chart illustrating the manner in which the data set is embedded in the available portions of the image.

### DETAILED DESCRIPTION OF SPECIFIC EMBODIMENTS

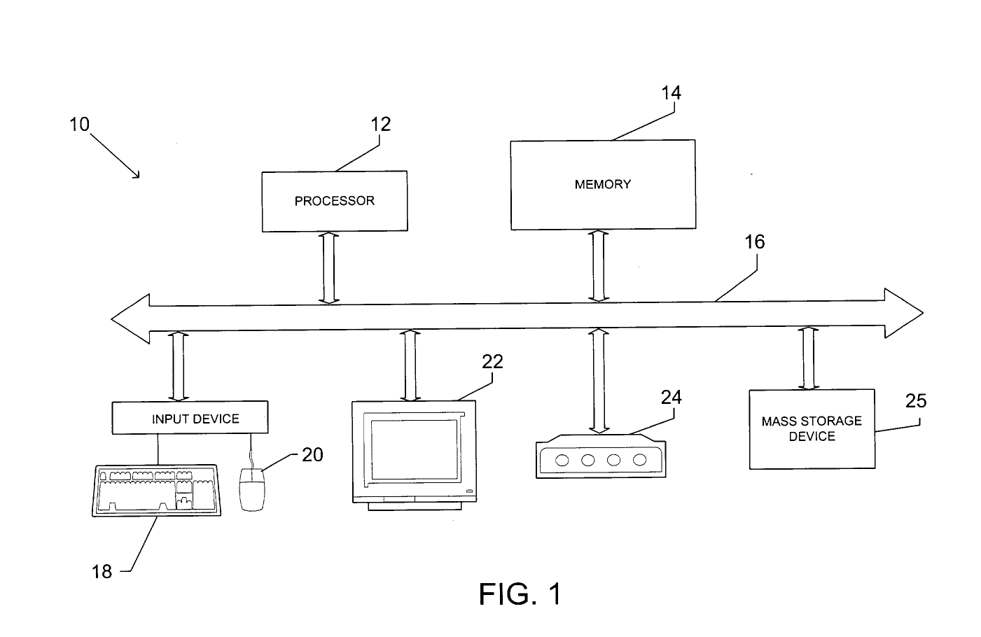

FIG. 1 shows a schematic of general-purpose computer system 10 which may be used to embed a data set in host data and store the resulting combined image. Computer system 10 generally comprises at least one processor 12, memory 14, input/output devices, and data pathways (e.g., buses) 16 connecting the processor, memory and input/output devices. Processor 12 accepts instructions and data from memory 14 and performs various operations such as embedding the data set in the host data. Processor 12 includes an arithmetic logic unit (ALU) that performs arithmetic and logical operations and a control unit that extracts instructions from memory 14 and decodes and executes them, calling on the ALU when necessary. The memory generally includes a random-access memory (RAM) and a read-only memory (ROM); however, there may be other types of memory such as programmable read-only memory (PROM), erasable programmable read-only memory (EPROM) and electrically erasable programmable read-only memory (EEPROM). Also, memory 14 preferably comprises an operating system, which executes on the processor 12. The operating system performs basic tasks that include recognizing input, sending output to output devices, keeping track of files and directories and controlling various peripheral devices.

The input/output devices comprise keyboard 18 and mouse 20 that enable a user to enter data and instructions into the computer system. Also, display 22 may be used to allow a user to see what the computer has accomplished. For example, the combined data can be displayed on display 22. Other output devices may include a printer, plotter, synthesizer and speakers. Communication device 24, such as a telephone or cable modem or a network card, such as an Ethernet adapter, local area network (LAN) adapter, integrated services digital network (ISDN) adapter, or Digital Subscriber Line (DSL) adapter, enables the computer system 10 to access other computers and resources on a network, such as a LAN or a wide area network (WAN).

Mass storage device 26 may be used to allow the computer system to permanently retain large amounts of data. The mass storage device may include all types of disk drives such as floppy disks, hard disks and optical disks, as well as tape drives that can read and write data onto a tape that could include digital audio tapes (DAT), digital linear tapes (DLT), or other magnetically coded media. The above-described computer system 10 can take the form of a hand-held digital computer, personal digital assistant computer, notebook computer, personal computer, workstation, mini-computer, mainframe computer or supercomputer.

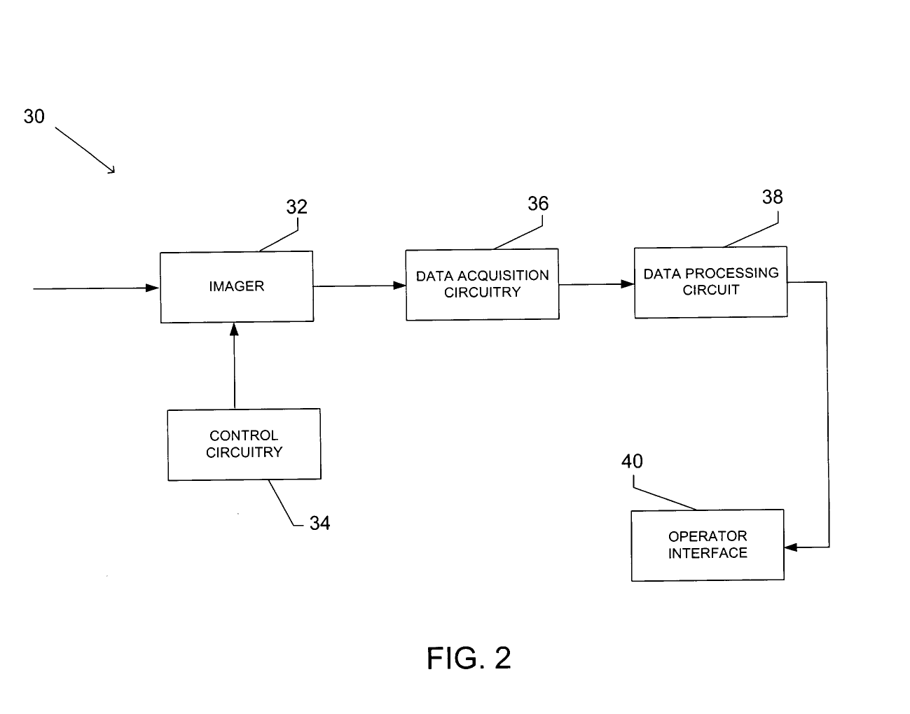

The method for embedding a data set in host data can be applied to medical images. FIG. 2 provides a general overview for exemplary imaging systems to which such a method can be applied in accordance with the embodiments of the invention.

Imaging system 30 generally includes some type of imager 32 that detects image data or signals and converts the signals to useful data. As described more fully below, the imager 32 may operate in accordance with various physical principles for creating the image data. In general, however, image data indicative of regions of interest in a patient are created by the imager either in a conventional support, such as photographic film, or in a digital medium.

The imager operates under the control of system control circuitry 34. The system control circuitry may include a wide range of circuits, such as radiation source control circuits, timing circuits, circuits for coordinating data acquisition in conjunction with patient or table of movements, circuits for controlling the position of radiation or other sources and of detectors, and so forth.

The imager 32, following acquisition of the image data or signals, may process the signals, such as for conversion to digital values, and forwards the image data to data acquisition circuitry 36. In the case of analog media, such as photographic film, the data acquisition circuitry may generally include supports for the film, as well as equipment for developing the film and producing hard copies. For digital systems, the data acquisition circuitry 36 may perform a wide range of initial processing functions, such as adjustment of digital dynamic ranges, smoothing or sharpening of data, as well as compiling of data streams and files, where desired.

The data is then transferred to data processing circuitry 38 where additional processing and analysis are performed. For conventional media such as photographic film, the data processing circuitry may apply textual information to films, as well as attach certain notes or patient-identifying information. For the various digital imaging systems available, the data processing circuitry perform substantial analyses of data, ordering of data, sharpening, smoothing, feature recognition, and so forth.

Ultimately, the image data is forwarded to some type of operator interface 40 for viewing and analysis. While operations may be performed on the image data prior to viewing, the operator interface 40 is at some point useful for viewing reconstructed images based upon the image data collected. It should be noted that in the case of photographic film, images are typically posted on light boards or similar displays to permit radiologists and attending physicians to more easily read and annotate image sequences. The images may also be stored in short or long term storage devices, for the present purposes generally considered to be included within the interface, such as picture archiving communication systems. The image data can also be transferred to remote locations, such as via a network.

It should also be noted that, from a general standpoint, the operator interface 40 affords control of the imaging system, typically through interface with the system control circuitry 34. Moreover, it should also be noted that more than a single operator interface 40 may be provided. Accordingly, an imaging scanner or station may include an interface which permits regulation of the parameters involved in the image data acquisition procedure, whereas a different operator interface may be provided for manipulating, enhancing, and viewing resulting reconstructed images.

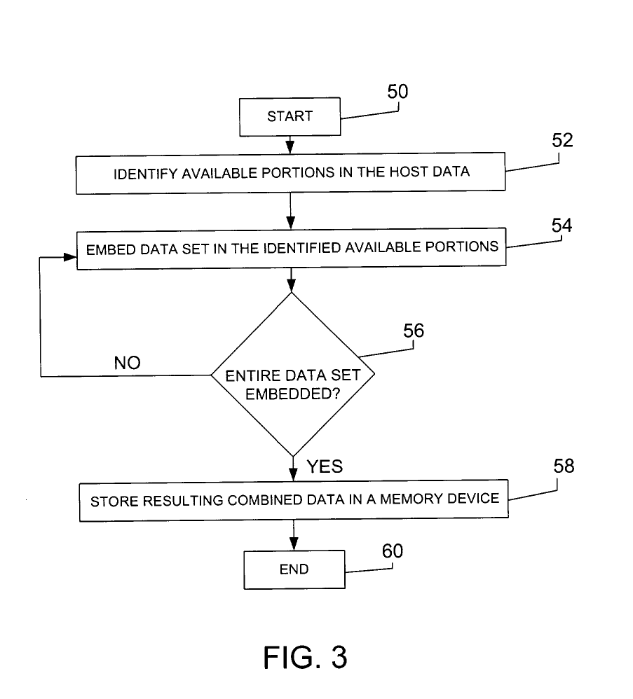

FIG. 3 is a flow chart illustrating the manner in which a data set can be embedded into host data. The method starts at step 50 and the control immediately passes over to step 52. Each step is described in further detail below.

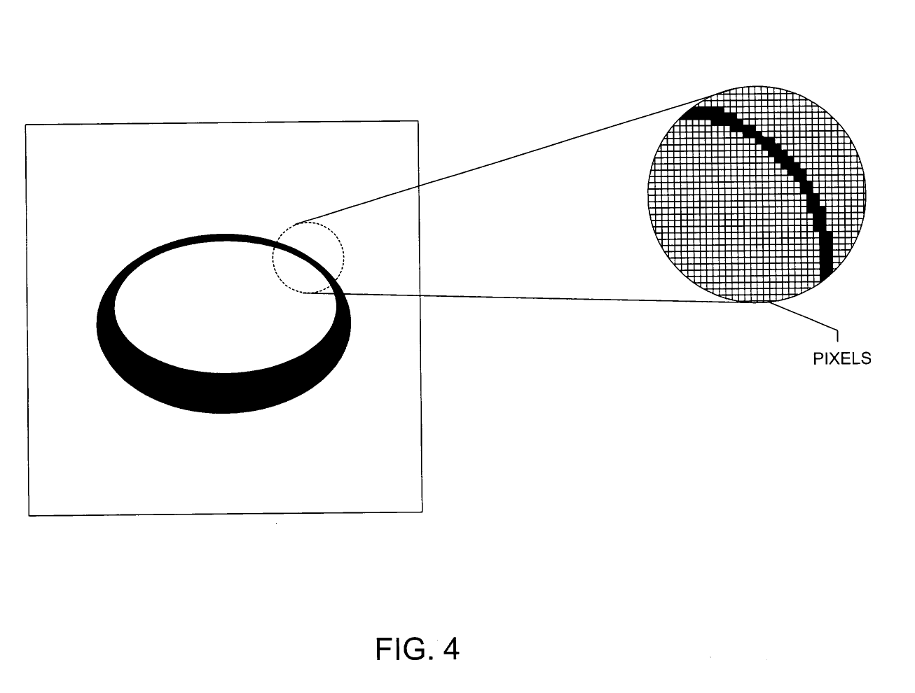

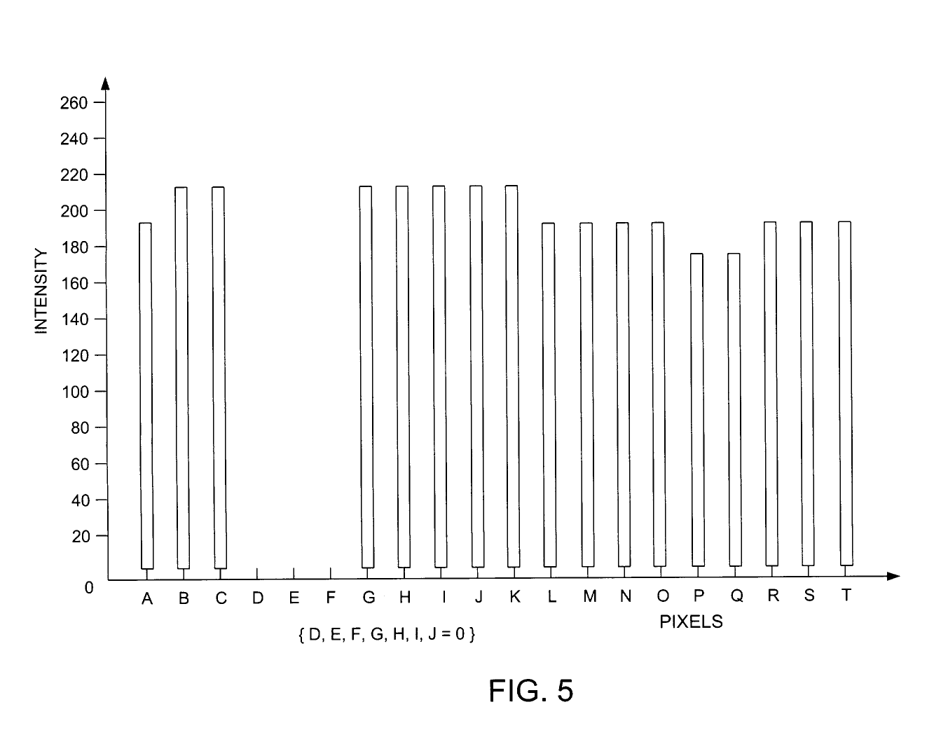

In step 52, available portions in the host data are identified. In an embodiment, the available portions are identified by identifying all run-lengths of zeros. In an example embodiment where the host data is a discrete pixel image as shown in FIG. 4, the run length equals three as shown in FIG. 5. In addition, the leading zero of the above-identified run-length is changed. For example, for a run length of 3, the leading zero of the identified run length is changed to a value of 255−3=252 indicating that the following two pixels are zeros.

In general, the method is based on two important observations applicable to most images. The first observation is that if the allowable dynamic range is [N, M] which means M−N+1 allowed grayscale intensity values, not all these values actually appear in the original image. The used dynamic range in reality is actually [n,m] where n<N and m<M. The second observation is that there is a significant amount of run-lengths of zeros (or some grayscale intensity value or some redundant compressible pattern) in an image, i.e. the image is not completely random. It may be noted that m and n may be positive or negative values.

In step 54, a data set is embedded in the identified available portions. Examples of data sets include a bound region of an image, color images, text, a mask, human readable indicia, machine-readable indicia, etc. The data set comprises values such as R1, R2-RK, if the data set represents text. Similarly, if the data set to be embedded is a region of interest (ROI), the co-ordinates of the contour can be embedded. Any kind of data set can be embedded depending upon the number of run-lengths in the host data.

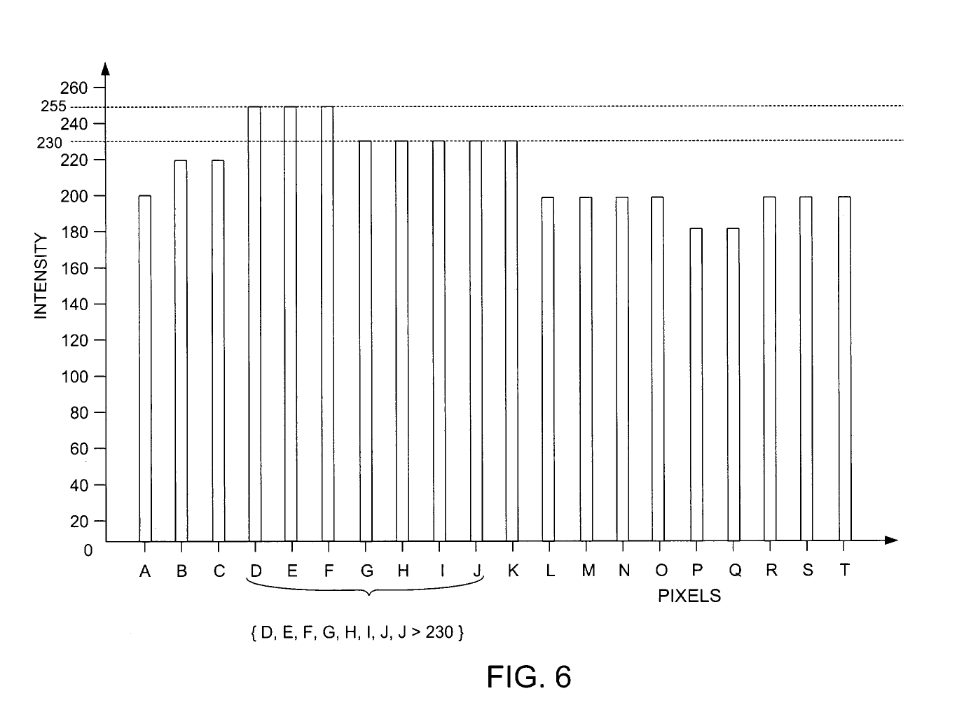

For illustration let R1 be the data set to be embedded, thus, D=R1. By splitting D into 4 sections with 4 bits each and adding MAX+1 (where MAX is the maximum intensity value present in the image), it is ensured that the 4 sections do not lie within [0,M] in which region all other pixels of the image lie. It may be noted that D1, D2, D3 and D4 do not exceed 255 (for an 8-bit image). In case any of D1-D4 exceeds 255, the section needs to be split further into 2 bits each or 1 bit each to avoid overflow. Thus, the first zero of the identified run-length is changed to 255-3, and the second and third zeros are changed to D1 and D2 representing the first and second section of data set D, as shown in FIG. 6.

In step 56, it is determined if the data set is embedded in the available portions identified. If yes, control passes to step 58, else control passes to step 54. Thus, the other sections of data set D are embedded in another identified available portion. In step 56, the resulting combined image is stored in a memory device such as memory 14 of the general computer system of FIG. 1.

When a user receives the combined image, he can reconstruct the image as follows. First, each pixel of the data set is assigned to the reconstructed image. If the value of the pixel ‘Y’ is greater than M, it indicates that Y is actually a zero and 255−Y is the run-length of zeros following this pixel. The next 255−Y pixels are extracted and the values of the pixels are the values of the data set. The next 255−Y are set to zero in the reconstructed image.

Another important observation made in a test image is that it has a considerable number of values equal to zero, which means a high number of clusters of run-lengths of zeros. In general, it is true that the statistics of many images show a high concentration of clusters of run-lengths of zeros. Hence the above method performs excellently in embedding considerable amounts of information.

For an image having all levels filed or unavailable for the foregoing process, the following method can be used. A Haar Wavelet transform (integer) or other algorithm can be used to transform the host image. The low pass version of the Haar transform is the average x0+x½ floored to the nearest integer and the high pass coefficient is the difference is x0−x1 (where x0, x1 are intensity values). Hence if an image had run-lengths of 255, the low pass coefficient would still be 255, whereas the high pass coefficient would be zero. When the low pass coefficient is 255, it can be automatically deduced that the corresponding high pass coefficient is a zero. Hence the high pass coefficient can be used to embed the data set to generate the combined data.

For example, assume a section of the image contained the following values:

24 26 102 104 255 255 255 255 255 255 243 240.

The low pass version would be 25 103 255 255 255 241. Similarly, the high pass version would be −2 −2 0 0 0 3.

Thus, the high pass version can be changed to −2 −2 x1 y1 x2 3 where x1, y1 and x3 are values of the data set that has to be embedded.

The above method may be used in various applications. For example, the method can be used for embedding a region of interest (ROI) in medical images. ROI contours which are bitmaps and which contain important information of the medical image (such as indicating a particular anatomy, lesions, cancerous regions, etc.) can be embedded in a medical image. The method can also be used for annotating the image. Applications could include medical imaging applications where sensitive information about the patient or any other information such as the patient name, age, sex, type of lesion/cancerous tissue, anatomical details, details regarding the scanner etc. can be embedded in the image so as to obtain a compact representation.

In addition, the method can be used for embedding an entire header in the data stream. The reason for doing this could be “increased error resilience,” due to the fact that loss of the header can render, reconstructing the data difficult. Using the above method, the header can be distributed in the image and hence given better error protection. The method can also be used for bar code embedding. Assuming a virtual catalogue of images of various products for an online-shopping mall such as books, electronic goods, clothes etc., are available, the bar code can be embedded in the thumbnail of the images which not only results in compact representation but also is easy to extract and handle.

The method can also be used to embed text in images. For example, in a medical image, the details of the image such as anatomy, etc. can be embedded in the image. User viewing the image can click on a particular part, and the text embedded can be displayed in a pop-up menu. The method can also be applied for an online database of human digital pictures (e.g. university students). Data such as student name, department, etc. can be embedded in the image.

The previously described embodiments of the present invention have many advantages, including lossless recovery of host data, lossless reconstruction of the embedded data set and zero-distortion of the embedded data set.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

What is claimed is:

1. A method for embedding a data set in a host data, said method comprising;
identifying available portions in the host data that are not required for lossless decoding of the host data;
embedding the data set in the available portions of the host data; and
storing the resulting combined data in a memory device.

2. The method of claim 1, wherein identifying comprises identifying an available portion of a dynamic range of the host data.

3. The method of claim 2, wherein said available portion is an upper end of the dynamic range.

4. The method of claim 3, wherein the available portion is identified by referring to a file header indicating a portion of the dynamic range utilized by the host data.

5. The method of claim 3, further comprising:
analyzing the host data to identify a portion of the dynamic range occupied by the host data.

6. The method of claim 1, further comprising transforming the host data into a high frequency component and a low freq component, wherein the available portion is a portion of the high frequency component.

7. The method of claim 6, wherein the available portion is identified by analyzing the host data corresponding to a position of the available portion.

8. The method of claim 7, wherein host data is analyzed to determine the portion of host data occupying a maximum dynamic range value.

9. The method of claim 1, wherein said host data includes data representative of an image.

10. The method of claim 1, wherein said embedded data represents a bound region of an image.

11. The method of claim 1, wherein said embedded data represents text.

12. The method of claim 1, wherein said embedded data represents a mask.

13. The method of claim 1, wherein said embedded data represents human readable indicia.

14. The method of claim 1, wherein said embedded data represents machine-readable indicia.

15. A method for embedding a data in a discrete pixel image, said method comprising;
identifying available portions in the discrete pixel image that are not required that are not required for lossless reconstruction of the image;
embedding the data in the available portions of the discrete pixel image; and
storing the resulting combined image in a memory device.

16. The method of claim 15, wherein said identifying comprises identifying an available portion of a dynamic range of the discrete pixel image.

17. The method of claim 16, wherein said available portion is an upper end of the dynamic range.

18. The method of claim 17, wherein the available portion is identified by referring to a file header indicating a portion of the dynamic range utilized by the discrete pixel image.

19. The method of claim 18, further comprising:
analyzing the discrete pixel image to identify a portion of the dynamic range occupied by the discrete pixel image.

20. The method of claim 17, further comprising transforming the discrete pixel image into a high frequency component and a low freq component, wherein the available portion is a portion of the high frequency component.

21. The method of claim 20, wherein the available portion is identified by analyzing the discrete pixel image corresponding to a position of the available portion.

22. The method of claim 21, wherein discrete pixel image is analyzed to determine the portion of discrete pixel image occupying a maximum dynamic range value.

23. The method of claim 16, wherein the available portion comprises spatial locations in the discrete pixel image.

24. The method of claim 16, wherein said available portion comprises temporal locations in the discrete pixel image.

25. The method of claim 15, wherein said embedded data represents a bound region of an image.

26. The method of claim 15, wherein said embedded data represents text.

27. The method of claim 15, wherein said embedded data represents mask.

28. The method of claim 15, wherein said embedded data represents human readable indicia.

29. The method of claim 15, wherein said embedded data represents machine-readable indicia.

30. A system for embedding a data set in a host data, said system comprising;
means for identifying available portions in the host data that are not required for lossless decoding of the host data;
means for embedding the data set in the available portions of the host data; and
means for storing the resulting combined data in a memory device.

31. The system of claim 30, wherein means for identifying comprises means for identifying an available portion of a dynamic range of the host data.

33. The system of claim 31, wherein said available portion is an upper end of the dynamic range.

34. The system of claim 33, wherein the available portion is identified by referring to a file header indicating a portion of the dynamic range utilized by the host data.

35. The system of claim 33, further comprising:
means for analyzing the host data to identify a portion of the dynamic range occupied by the host data.

36. The system of claim 31, further comprising means for transforming the host data into a high frequency component and a low freq component, wherein the available portion is a portion of the high frequency component.

37. The system of claim 36, wherein the available portion is identified by analyzing the host data corresponding to a position of the available portion.

38. The system of claim 37, wherein host data is analyzed to determine the portion of host data occupying a maximum dynamic range value.

39. The system of claim 31, wherein said host data includes data representative of an image.

40. The system of claim 31, wherein said embedded data represents a bound region of an image.

41. The system of claim 31, wherein said embedded data represents text.

42. The system of claim 31, wherein said embedded data represents a mask.

43. The system of claim 31, wherein said embedded data represents human readable indicia.

44. The system of claim 31, wherein said embedded data represents machine-readable indicia.
